(19) United States
(12) Patent Application Publication
(10) Pub. No.: US 2005/0283458 A1
(43) Pub. Date: Dec. 22, 2005

(54) Automatic detection of frequently used query patterns in a query workload

(75) Inventors: Cesar A. Galindo-Legaria, Redmond, WA (US); Florian M. Waas, Seattle, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation, Redmond, WA (US)

(21) Appl. No.: 10/873,529

(22) Filed: Jun. 22, 2004

(51) Int. Cl. G06F 7/00

(52) U.S. Cl. 707/1

(57) ABSTRACT

In the course of an optimization, a query can be broken down into its sub-expressions. Materialized views may be substituted for the sub-expressions during query optimization. Encoded sub-expressions are generated and used in the comparison with stored materialized views. Instead of discarding the encoding of a query's sub-expression if no matching materialization is found, the encoding is stored. If subsequently submitted queries contain the same sub-expression, a view matching mechanism will find the previously stored encoding. Because no materialization is associated with this expression, the view is not substituted. However, usage statistics counters are updated; e.g., a counter is incremented indicating that the sub-expression was found in another query. Because view matching is applied to the sub-expression that are candidates for being materialized, the statistics accurately reflect which are the most frequently occurring candidate sub-expressions in a workload. Users can view and analyze the types and frequencies of sub-expressions found in a workload by querying a system table or virtual table. The table provides an accurate, up-to-date workload synopsis without requiring additional tools or incurring the overhead of client-side tools.

### TECHNICAL FIELD

The present invention relates generally to the field of information storage and retrieval, and, more particularly, to query optimization.

### BACKGROUND

Materialized views have been a subject of database research for over a decade. The basic idea is to materialize, or store, the result of some query, then use such computed result when similar queries are submitted to the database. For example, it may be desirable to store the result of sales per day, for example, and use the result (this materialized view) in the future to answer related queries, such as sales in a given month or total sales in the year.

For additional flexibility, applications should not need to be aware that certain views exist, or are materialized. The query processor should identify matches between user queries and existing pre-computed results (materialized views), and use such results when applicable. This is known as the view utilization problem: Given a user query written over base tables, as well as a collection of materialized views, which materialized views can be used to answer such query? And the cost-based variant of the question: Which of those materialized views should be used?

Materialized views should be part of the physical design of a database and their primary purpose is to improve performance. The logical design of the database and correctness of applications should be independent of the presence or absence of materialized views. Materialized views can introduce dramatic improvements in query performance.

Query optimizers are normally structured such that there is an initial simplification stage, followed by exploration of alternatives and cost-based selection of an execution plan, as shown in FIG. 1.

During the simplification/normalization stage 2, some changes are made on the original query Q, such as pushing selections down, or rewriting a subquery as a join, when possible. These modifications are aimed at obtaining a “better” query. Typically, there is no detailed cost estimation at this stage, and a single “better” query Q′ is produced as the result.

The second stage 5 (exploration and cost-based selection) in optimization is directed to generating multiple alternatives, and using a detailed cost model to select the alternative with the cheapest estimated execution cost. Two conventional architectures for the exploration stage are bottom-up, dynamic programming join enumeration, and transformation-driven generation of alternatives. Both architectures set up a table of alternatives, as is well known, which compactly encodes the various possibilities for each sub-expression of a query.

Considering materialized views during exploration comprises augmenting the table of alternatives with entries that use such materialized views. Selecting the right or best materialized view is a difficult problem. Prior art techniques are slow and expensive.

Tuning a database by creating materialized views (i.e., pre-computed query expressions) can reduce query response times significantly. The choice of materialized views depends primarily on the query workload rather than, for example, the physical layout of the database. Thus, in order to tune a database in the most desirable manner, a representative workload of queries has to be captured and analyzed. This process and its result is referred to as workload analysis. Central to the concept of workload analysis is identifying frequently recurring query patterns. After the most frequently used patterns are identified, matching materialized views can be created. This query pattern is also referred to as a candidate expression. When the appropriate materialized views have been created, the query optimizer (part of the database system) will utilize the materialized views in a cost-based manner. In other words, the optimizer determines the expected benefit from a materialized view and chooses the least costly alternative.

The current state-of-the-art is to perform workload analyses on the textual representation of the queries, i.e., queries are recorded as they are submitted to the database system and a separate tool does the actual analysis. This involves several problems.

One problem is that a query has to be broken down into its sub-queries because the most beneficial candidate expressions for pre-computation are typically sub-queries which occur also in other queries. This decomposition is possible but has to be kept aligned with the optimization techniques of the query optimizer. If the decomposition differs from the one internally used by the optimizer, the optimizer will not be able to match and use the views. The alignment is fragile in that upgrading the database to the next version or even just applying service packs can diminish the effectiveness of the workload analysis tool substantially.

Another problem is that the external tool has to anticipate which choices the optimizer would make. Therefore, the tool has to verify its recommendations, creating the materialized views and re-running the queries to check whether the given choice of materialized views did actually improve the performance. Most database systems offer mechanisms to shortcut the creation of the materialized views; however, a significant overhead is incurred by re-optimizing the queries to check for proper usage of the newly created structures. The verification is typically by orders of magnitude slower than the original query workload as a multitude of combinations has to be tested.

In view of the foregoing deficiencies in existing data storage and database technologies, there is a need for efficient uses of materialized views. The present invention satisfies these needs.

### SUMMARY

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

The invention relates to a query optimizer that transforms an originally submitted query into an execution plan (e.g., determines the order in which data is to be processed). The individual transformations apply to sub-expressions of the original query. The size of the sub-expressions depends on capabilities of the individual transformations—some process the complete query while others only small parts of it.

In the course of an optimization, a query can be broken down into its sub-expressions. Materialized views may be substituted for the sub-expressions during query optimization. Encoded sub-expressions are generated and used in the comparison with stored materialized views. The invention modifies conventional view utilization procedures, and instead of discarding the encoding of a query's sub-expression if no matching materialization is found, the encoding is stored in a catalog (e.g., a view cache). If subsequently submitted queries contain the same sub-expression, a view matching mechanism will find the previously stored encoding. Because no materialization is associated with this expression, the view is not substituted. However, usage statistics counters are updated; e.g., a counter in a catalog is incremented indicating that the sub-expression was found in another query. Because view matching is applied to the sub-expression that are candidates for being materialized, the statistics accurately reflect which are the most frequently occurring candidate sub-expressions in a workload. Users can view and analyze the types and frequencies of sub-expressions found in a workload by querying a system table or virtual table, for example. The table provides an accurate, up-to-date workload synopsis without requiring additional tools or incurring the overhead of client-side tools.

According to aspects of the invention, new candidate expressions are identified and stored during each optimization. The expressions are rated by keeping statistics about their usage and collecting feedback about their performance. No verification is required since the candidates have been identified already during the regular optimization.

According to further aspects of the invention, the data is exposed to a user or administrator, for example, through a database table and can be queried with standard query techniques (e.g., SQL). This table provides a synopsis of the workload. Changes in the workload over time are reflected by the usage statistics kept for each candidate expression.

Other features and advantages of the invention may become apparent from the following detailed description of the invention and accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of a conventional query optimizer;

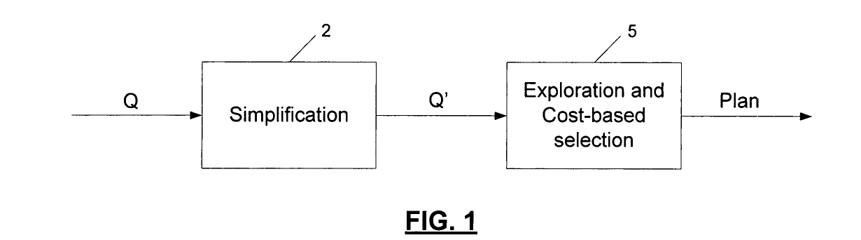

FIG. 2 is a block diagram representing a computer system in which aspects of the present invention may be incorporated;

FIG. 3 is a block diagram illustrating a computer system divided into three component groups: the hardware component, the operating system component, and the applications programs component;

FIG. 4 illustrates an exemplary storage platform that can be used with the present invention; and

FIG. 5 is a flow diagram of an exemplary method of detecting frequently used query sub-expressions in a query workload in accordance with the present invention.

### DETAILED DESCRIPTION

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

Exemplary Computing Environment

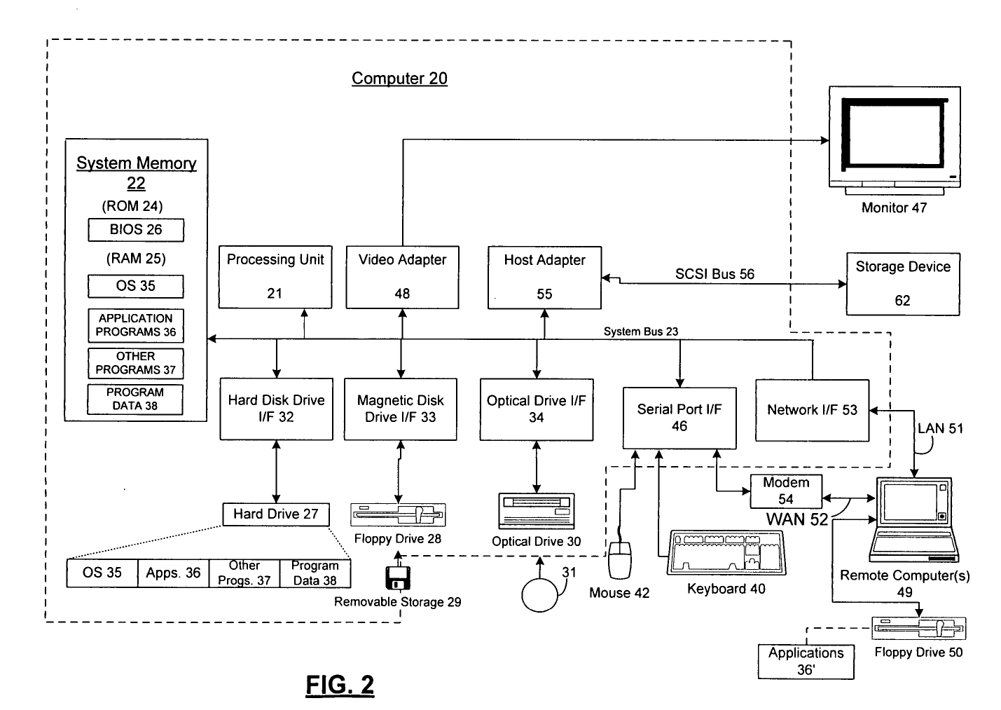

Numerous embodiments of the present invention may execute on a computer. FIG. 2 and the following discussion are intended to provide a brief general description of a suitable computing environment in which the invention may be implemented. Although not required, the invention will be described in the general context of computer executable instructions, such as program modules, being executed by a computer, such as a client workstation or a server. Generally, program modules include routines, programs, objects, components, data structures and the like that perform particular tasks or implement particular abstract data types. An “object” is a unit of storable information accessible to a hardware/software interface system that has a basic set of properties that are commonly supported across all objects exposed to an end-user by the hardware/software interface system shell. Objects also have properties and relationships that are commonly supported across all types including features that allow new properties and relationships to be introduced.

Moreover, those skilled in the art will appreciate that the invention may be practiced with other computer system configurations, including handheld devices, multiprocessor systems, microprocessor based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

As shown in FIG. 2, an exemplary general purpose computing system includes a conventional personal computer 20 or the like, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start up, is stored in ROM 24.

The personal computer 20 may further include a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28, and optical disk drive 30 are connected to the system bus 23 by a hard disk drive interface 32, a magnetic disk drive interface 33, and an optical drive interface 34, respectively. The drives and their associated computer readable media provide nonvolatile storage of computer readable instructions, data structures, program modules and other data for the personal computer 20.

Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs) and the like may also be used in the exemplary operating environment.

A number of program modules may be stored on the hard disk, magnetic disk 29, optical disk 31, ROM 24 or RAM 25, including an operating system 35, one or more application programs 36, other program modules 37 and program data 38. A user may enter commands and information into the personal computer 20 through input devices such as a keyboard 40 and pointing device 42. Other input devices (not shown) may include a microphone, joystick, game pad, satellite disk, scanner or the like. These and other input devices are often connected to the processing unit 21 through a serial port interface 46 that is coupled to the system bus, but may be connected by other interfaces, such as a parallel port, game port or universal serial bus (USB). A monitor 47 or other type of display device is also connected to the system bus 23 via an interface, such as a video adapter 48. In addition to the monitor 47, personal computers typically include other peripheral output devices (not shown), such as speakers and printers. The exemplary system of FIG. 2 also includes a host adapter 55, Small Computer System Interface (SCSI) bus 56, and an external storage device 62 connected to the SCSI bus 56.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 2. The logical connections depicted in FIG. 2 include a local area network (LAN) 51 and a wide area network (WAN) 52. Such networking environments are commonplace in offices, enterprise wide computer networks, intranets and the Internet.

When used in a LAN networking environment, the personal computer 20 is connected to the LAN 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

While it is envisioned that numerous embodiments of the present invention are particularly well-suited for computerized systems, nothing in this document is intended to limit the invention to such embodiments. On the contrary, as used herein the term “computer system” is intended to encompass any and all devices comprising press buttons, or capable of determining button presses, or the equivalents of button presses, regardless of whether such devices are electronic, mechanical, logical, or virtual in nature.

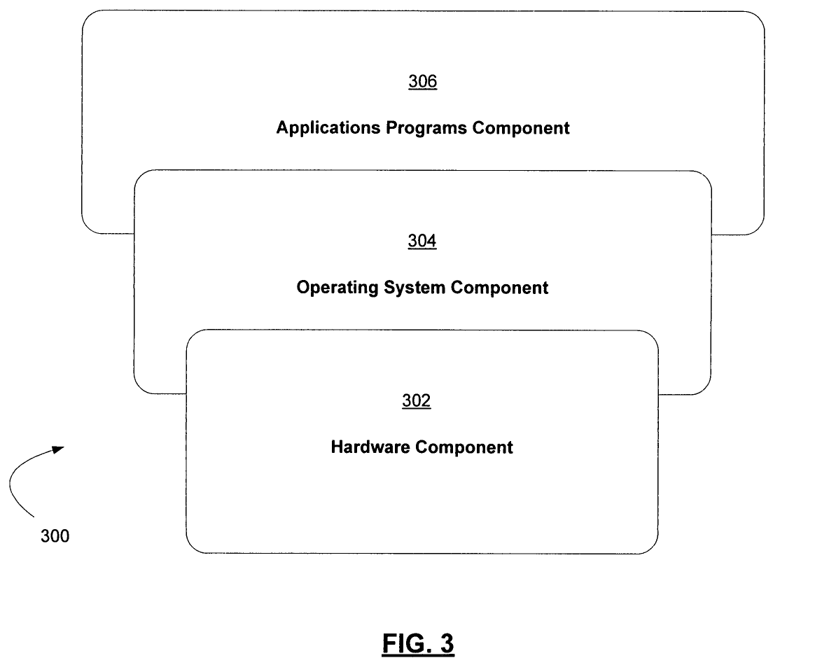

As illustrated in the block diagram of FIG. 3, a computer system 300 can be roughly divided into three component groups: the hardware component 302, the operating system component 304, and the applications programs component 306.

In certain computer systems 300, and referring back to FIG. 2, the hardware 302 may comprise the central processing unit (CPU) 21, the memory (both ROM 24 and RAM 25), the basic input/output system (BIOS) 26, and various input/output (I/O) devices such as a keyboard 40, a mouse 42, a monitor 47, and/or a printer (not shown), among other things. The hardware component 302 comprises the basic resources for the computer system 300.

The applications programs component 306 comprises various software programs including but not limited to compilers, database systems, word processors, business programs, videogames, and so forth. Application programs provide the means by which computer resources are utilized to solve problems, provide solutions, and process data for various users (e.g., machines, other computer systems, and/or end-users).

The operating system component 304 comprises the operating system itself and its shell and kernel. An operating system (OS) is a special program that acts as an intermediary between application programs and computer hardware, and the purpose of an operating system is to provide an environment in which a user can execute application programs. The goal of any operating system is to make the computer system convenient to use, as well as utilize the computer hardware in an efficient manner.

The operating system is generally loaded into a computer system at startup and thereafter manages all of the application programs (or simply “applications”) in the computer system. The application programs interact with the operating system by requesting services via an application program interface (API). Some application programs enable end-users to interact with the operating system via a user interface such as a command language or a graphical user interface (GUI).

An operating system traditionally performs a variety of services for applications. In a multitasking operating system where multiple programs may be running at the same time, the operating system determines which applications should run in what order and how much time should be allowed for each application before switching to another application for a turn. The operating system also manages the sharing of internal memory among multiple applications, and handles input and output to and from attached hardware devices. The operating system also sends messages to each application (and, in certain cases, to the end-user) regarding the status of operations and any errors that may have occurred.

An operating system's shell is the interactive end-user interface to an operating system. A shell is the outer layer of an operating system that is directly accessible by application programs and even directly by end-users. In contrast to a shell, the kernel is an operating system's innermost layer that interacts directly with the hardware components.

As well understood by those of skill in the relevant art, “files” are entities of information (including but not limited to the operating system itself, as well as application programs, data sets, and so forth) that are capable of being manipulated as discrete (storable and retrievable) entities by an operating system. In modern operating systems, files are the basic units of storable information (e.g., data, programs, and so forth) that are manipulated by the operating system, and groups of files are organized in “folders”.

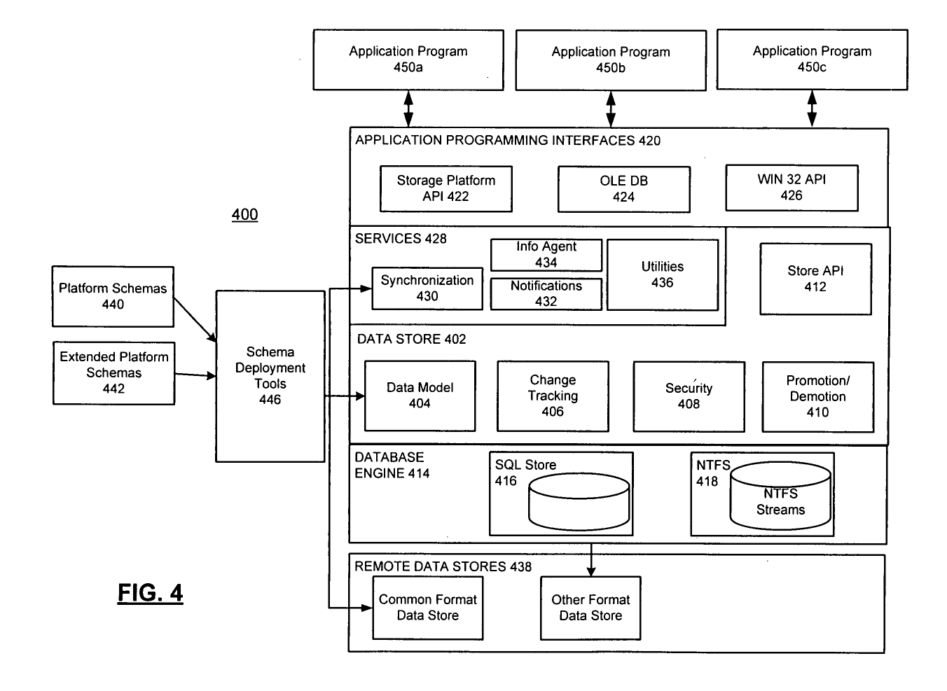

A storage platform for organizing, searching, and sharing data that can be used with the present invention is designed to be the store for all types of data. Referring to FIG. 4, a storage platform 400 in accordance with the present invention comprises a data store 402 implemented on a database engine 414. In one embodiment, the database engine comprises a relational database engine with object relational extensions. In one embodiment, the relational database engine 414 comprises the Microsoft SQL Server relational database engine.

The data store 402 implements a data model 404 that supports the organization, searching, sharing, synchronization, and security of data. Specific types of data are described in schemas, such as schemas 440, 442 and the storage platform 400 provides tools 446 for deploying those schemas as well as for extending those schemas.

A change tracking mechanism 406 implemented within the data store 402 provides the ability to track changes to the data store. The data store 402 also provides security capabilities 408 and a promotion/demotion capability 410. The data store 402 also provides a set of application programming interfaces 412 to expose the capabilities of the data store 402 to other storage platform components and application programs (e.g., application programs 450a, 450b, and 450c) that utilize the storage platform.

The storage platform of the present invention still further comprises an application programming interface (API) 420, which enables application programs, such as application programs 450a, 450b, and 450c, to access all of the foregoing capabilities of the storage platform and to access the data described in the schemas. The storage platform API 422 may be used by application programs in combination with other APIs, such as the OLE DB API 424 and the Microsoft Windows Win32 API 426.

The storage platform 400 of the present invention may provide a variety of services 428 to application programs, including a synchronization service 430 that facilitates the sharing of data among users or systems. For example, the synchronization service 430 may enable interoperability with other data stores 438 having the same format as data store 402, as well as access to data stores having other formats. The storage platform 400 also provides file system capabilities that allow interoperability of the data store 402 with existing file systems, such as the Windows NTFS files system 418. A SQL store 416 may also be provided.

In at least some embodiments, the storage platform 400 may also provide application programs with additional capabilities for enabling data to be acted upon and for enabling interaction with other systems. These capabilities may be embodied in the form of additional services 428, such as an Info Agent service 434 and a notification service 432, as well as in the form of other utilities 436.

In at least some embodiments, the storage platform is embodied in, or forms an integral part of, the hardware/software interface system of a computer system. A “hardware/software interface system” is software, or a combination of hardware and software, that serves as the interface between the underlying hardware components of a computer system and applications that execute on the computer system. A hardware/software interface system typically comprises (and, in some embodiments, may solely consist of) an operating system. A hardware/software interface system may also comprise a virtual machine manager (VMM), a Common Language Runtime (CLR) or its functional equivalent, a Java Virtual Machine (JVM) or its functional equivalent, or other such software components in the place of or in addition to the operating system in a computer system. The purpose of a hardware/software interface system is to provide an environment in which a user can execute application programs.

The data store 402 of the storage platform 400 of the present invention implements a data model that supports the organization, searching, sharing, synchronization, and security of data that resides in the store.

### Exemplary Embodiments

A materialized view may be used to enhance querying. A typical materialized view contains data entries and could contain associated sub-entries or other dependent or derived data. A materialized view might contain the results of a function invocation that transforms the data.

The query optimizer of a database system transforms an originally submitted query into an execution plan which determines the order in which data is to be processed, for example. In the course of an optimization, the original query is broken down into sub-expressions. Individual transformations are applied to the sub-expressions The size of the sub-expressions depends on the capabilities of the individual transformations. Some transformations may be able to process the complete query, while other transformations may be able to process only small parts of the query.

One type of transformation that may be applied during optimization is referred to as view utilization. In view utilization, the query optimizer checks whether a given sub-expression can be substituted with a previously created and stored result, such as a previously created materialized view. In particular, the optimizer encodes the sub-expression and compares it with previously encoded sub-expressions that have been stored in a storage device. An exemplary storage device could be a database catalog, for example. If a matching materialized view (i.e., a materialization of the sub-expression) is found in the storage device, the sub-expression can be substituted with the materialized view.

If no matching materialized view is found in the storage device, the encoded sub-expression is stored in the storage device also (e.g., in a catalog or view cache). Thus, instead of discarding the encoding of the query's sub-expression, it is maintained in storage. If subsequently submitted queries contain the same sub-expression, the view matching mechanism will find the previously stored encoding. Because no materialization was associated with this encoded sub-expression, no materialized view is not substituted. However, a usage statistics counter associated with the stored encoded sub-expression is updated to indicate that the sub-expression was found in another query. Each stored sub-expression desirably has a counter associated with it. Each counter is desirably stored in the storage device and is incremented each time a sub-expression corresponding to its associated sub-expression is received and compared to the encoded sub-expressions residing in storage. Moreover, each stored materialized view desirably has a counter associated with it, and is incremented whenever a sub-expression that can be replaced with that materialized view is received.

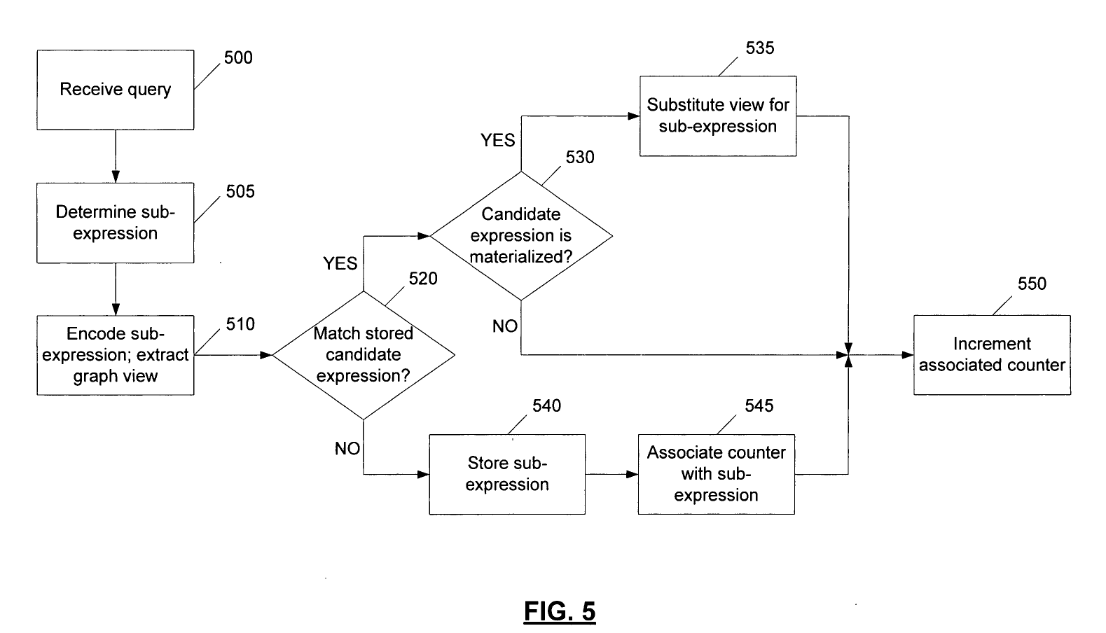

FIG. 5 is a flow diagram of an exemplary method of detecting frequently used query sub-expressions in a query workload in accordance with the present invention. A query, such as a SQL statement, is received at step 500, and a sub-expression of the query is determined at step 505. In particular, for example, the SQL statement gets converted to a tree of sub-expressions during query optimization, using techniques well-known in the art. At this point, it might be desirable to materialize some or all of the sub-expressions of the tree in order to improve performance. It is noted that during optimization, materializations are used (i.e., matched). The materialization may be performed by a separate task.

The sub-expression is compared to the stored candidate expressions, i.e., materialized views and previously tracked sub-expressions, at step 520 to determine if there is a match. Desirably, materialized views and tracked sub-expressions are not distinguished. Providing counters for materialized views may help determine their usefulness. More particularly, for example, a graph view representation from the sub-expression is extracted at step 510 along with graph view representations from each of the stored candidate expressions. Thus, each sub-expression from the tree that may be able to be used to generate a materialized view is encoded to extract a graph view representation, using techniques well-known in the art. A sub-expression may be used to generate a materialized view if it is deterministic, for example.

Thus, the graph view representation that was extracted from the encoded sub-expression is compared to graph view representations extracted from stored candidate expressions (which may be stored in a storage device or lookup table, for example). Comparisons may be performed in accordance with certain matching rules, such as alternatives (e.g., “order-customer” is the same as “customer-order”).

If the sub-expression (e.g., encoded graph view representation of the sub-expression) matches a previously stored candidate expression at step 520, two cases can be distinguished at step 530: (1) the candidate expression corresponds to an existing materialized view (e.g., encoded graph view representation of the materialized view), then the materialized view is substituted into the query for the sub-expression, at step 535, or (2) the candidate expression is a previously tracked sub-expression which does not correspond to any existing materialized view

On the other hand, if there is no match between the sub-expression and any of the stored candidate expressions the sub-expression is stored in a storage device (e.g., in a lookup table), at step 540. Thus, for example, if there is no match at step 520, then the graph view representation that was extracted from the encoded sub-expression is saved (e.g., in a metadata catalog or other storage device) at step 540, A counter is associated with the newly stored sub-expression at step 545.

In all cases, the counter associated with the candidate expression is incremented indicating a successful match, i.e., potential or actual utilization of the expression for the current query optimization task at step 550.

As noted above, a counter is associated with the stored sub-expression, at step 545. The counter can be stored in a system table, virtual table, or other storage device that may be accessed by a user or other application. The counter is desirably incremented each time a sub-expression is received that is equivalent to the stored sub-expression. As noted above, counters for materialized views may also be maintained because this may help determine their usefulness.

In this manner, a count of the number of times a particular sub-expression (and its equivalents), that is not a materialized view, has appeared in queries is maintained and can be provided at any time. Thus, statistics about query structures can be generated and provided to users and applications. Such information can be used to develop patterns and other statistics and workload analysis. The usage statistics may refer to query patterns that are shared across workloads. The patterns can be of any granularity from single table selects to large join queries including a limited set of aggregates. By collecting statistics about how many times certain patterns occur in a query workload, users can determine what materialized views (or statistics only views) would be useful for their particular workload.

If a subsequently received sub-expression is found not to have a stored materialized view and not to have been stored previously, then this subsequently received sub-expression is also stored (e.g., in the system table or virtual table) and a separate counter is associated with it.

It is contemplated that the elements in the view cache or other storage are subject to eviction based on memory limitations. In other words, the information available depends on the amount of memory available in the system. Workload analysis may depend on the eviction mechanism as the query workload might change; i.e., the number of expressions for which statistics are collected is unbound.

Because view matching is applied to all sub-expressions which are candidates for being materialized, the counter statistics accurately reflect those sub-expressions that are the most frequently occurring candidate sub-expressions in a workload. Applications and users can access the counter information, by querying a system table or virtual table, for example. This counter information can be used to analyze the types, patterns, and frequencies of sub-expressions found in an application workload. The system table or virtual table identifies the frequently occurring sub-expressions. The table desirably provides an accurate, up-to-date workload synopsis without requiring additional tools or incurring the overhead of client-side tools.

### CONCLUSION

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

1. A method for recording data comprising:
receiving a plurality of queries;
obtaining at least one sub-expression for each query;
identifying duplicate occurrences of each sub-expression in the queries;
determining occurrence statistics on each sub-expression; and
maintaining a stored representation of the occurrence statistics for each sub-expression.

2. The method of claim 1, wherein the plurality of queries is provided in its entirety for analysis.

3. The method of claim 1, wherein the plurality of queries is provided in a streaming fashion and analyzed one by one.

4. The method of claim 1, wherein the plurality of queries is an observed sequence submitted by an application for their compilation and execution in a database management system.

5. The method of claim 1, wherein the at least one sub-expressions of each query is obtained by using syntactic rules on the original form of the queries.

6. The method of claim 1, wherein the at least one sub-expressions of each query is obtained by using semantic rules yielding expressions that can be used to answer the query.

7. The method of claim 1, wherein the at least one sub-expressions of each query is obtained by taking sub-plans generated by a query optimizer in its process of plan enumeration.

8. The method of claim 1, wherein the at least one sub-expressions of each query is obtained in a process of attempting materialized view matching in a query compiler.

9. The method of claim 1, wherein identifying duplicate occurrences of each sub-expression in the queries is performed based on syntactical equality of the expressions.

10. The method of claim 1, wherein identifying duplicate occurrences of each sub-expression in the queries is performed based on semantic equality of the expressions.

11. The method of claim 1, wherein identifying duplicate occurrences of each sub-expression in the queries is performed using algorithms for materialized view matching.

12. The method of claim 1, wherein the occurrence statistics comprise a list of queries in which a given sub-expression is obtained.

13. The method of claim 1, wherein the occurrence statistics comprise a count of the number of queries in which a given sub-expression is obtained.

14. The method of claim 1, wherein the occurrence statistics comprise the first or last time in which a given sub-expression is obtained.

15. The method of claim 1, wherein a single store is used to maintain information about materialized views as well as sub-expression statistics.

16. The method of claim 1, wherein a sub-expression storage entry comprises the identification of a materialized view that is semantically equivalent to said sub-expression.

17. The method of claim 1, further comprising, for each sub-expression, an attempt is made to match with an existing materialized view; only if that fails is a new storage entry created in a data store for the sub-expression.

18. A method for maintaining data related to a query, comprising:
receiving a query;
determining a sub-expression of the query;
determining if the sub-expression matches any previously stored materialized view of a plurality of previously stored materialized views;
substituting the matching previously stored materialized view for the sub-expression in the query, if the sub-expression matches the previously stored materialized view;
storing the sub-expression in a storage device, if the sub-expression fails to match any of the previously stored materialized views.

19. The method of claim 18, further comprising associating a counter with the sub-expression that is stored in the storage device.

20. The method of claim 19, further comprising storing the counter in a system table.

21. The method of claim 20, further comprising:
receiving a second sub-expression after associating the counter with the sub-expression that is stored in the storage device;
determining if the second sub-expression matches the stored sub-expression; and
incrementing the counter if the second sub-expression matches the stored sub-expression.

22. The method of claim 21, further comprising retrieving the count of the counter and outputting the count.

23. The method of claim 21, further comprising:
determining if the second sub-expression matches any previously stored materialized view of the plurality of previously stored materialized views;
substituting the matching previously stored materialized view for the second sub-expression, if the second sub-expression matches the previously stored materialized view;
storing the second sub-expression in the storage device, if the second sub-expression fails to match any of the previously stored materialized views.

24. The method of claim 23, further comprising associating a counter with the second sub-expression that is stored in the storage device.

25. The method of claim 18, wherein determining if the sub-expression matches any previously stored materialized view comprises:
extracting a graph view representation from the sub-expression;
extracting a graph view representation from each of the plurality of previously stored materialized views; and
comparing the extracted graph view representation from the sub-expression with the extracted graph view representations from each of the previously stored materialized views.

26. The method of claim 18, wherein storing the sub-expression in a storage device comprises storing the sub-expression in a lookup table.

27. A computer system comprising:
a data store comprising a plurality of materialized views; and
a processor for receiving a sub-expression of a query, determining if the sub-expression matches any of the materialized views, substituting the matching materialized view for the sub-expression in the query if the sub-expression matches the materialized view, and storing the sub-expression in a storage device if the sub-expression fails to match any of the materialized views.

28. The computer system of claim 27, wherein the storage device comprises a lookup table.

29. The computer system of claim 27, wherein the processor determines if the sub-expression matches any materialized view by extracting a graph view representation from the sub-expression, extracting a graph view representation from each of the plurality of materialized views, and comparing the extracted graph view representation from the sub-expression with the extracted graph view representations from each of the materialized views.

30. The computer system of claim 27, further comprising a counter associated with the sub-expression that is stored in the storage device.

31. The computer system of claim 30, further comprising a system table that stores the counter.

32. The computer system of claim 31, wherein the processor receives a second sub-expression after associating the counter with the sub-expression that is stored in the storage device, determines if the second sub-expression matches the stored sub-expression, and increments the counter if the second sub-expression matches the stored sub-expression.

33. The computer system of claim 31, wherein the processor retrieves the count of the counter and outputs the count.

34. The computer system of claim 31, wherein the processor determines if the second sub-expression matches any of the plurality of materialized views, substitutes the matching materialized view for the second sub-expression if the second sub-expression matches the materialized view, and stores the second sub-expression in the storage device if the second sub-expression fails to match any of the materialized views.

35. The computer system of claim 34, further comprising another counter associated with the second sub-expression that is stored in the storage device.
